(19) United States
(12) Patent Application Publication
(10) Pub. No.: US 2004/0189876 A1
(43) Pub. Date: Sep. 30, 2004

(54) Remote video recognition system

(76) Inventor: Norimitu Shirato, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/480,248

(22) PCT Filed: Jun. 12, 2002
(86) PCT No.: PCT/JP02/05849

(30) Foreign Application Priority Data
Jun. 13, 2001 (JP) 2001-178524
Jun. 7, 2002 (JP) 2002-167364

(51) Int. Cl. H04N 5/14

(52) U.S. Cl. 348/700; 348/169

(57) ABSTRACT

A remote video recognition system is provided which realizes a new, one-source-multiscreen image reception system. The system comprises an imaging means such as a CCD device (4), a transmission means (5) for transmitting a video shot by the imaging means, and a display means (8) installed in a remote place (6) to receive video information transmitted from the transmission means and display the video information. The imaging means has a fish-eye lens (1) that can capture a curved image with a wide viewing angle. The transmission means can transmit the video shot by the imaging means to a desired location via the Internet (9). The imaging means, the transmission means or the display means (8) is provided with an input device that can select and specify an arbitrary range or area of the image. The selected arbitrary range or area of the image is automatically tracked.

### BACKGROUND OF THE INVENTION

1. Technical Field of the Invention

The present invention relates to a remote video recognition system applied, for example, to a surveillance system and capable of outputting and displaying a video produced by an imaging means, including projection lenses such as a fish-eye lens and hemispherical reflection mirrors such as a convex mirror, in any desired form at a site remote from where the imaging means is installed.

2. Background of the Invention

Significant advances have been made in the computer-related technologies in recent years. Particularly, technologies (software) associated with computer graphics have progressed remarkably as the processing speed of the computer itself and the storage capacities are increasing. The use of graphics processing software allows figures or images taken into the computer to be not only enlarged or reduced but also deformed arbitrarily. Deforming or morphing an image taken into the computer currently involves breaking down the image into pixels and performing complicated computations on each of the pixels to produce a desired deformed image.

However, since the image deformation processing described above requires performing complex calculations for each pixel, its practical application has been limited to drawing. When such image deformation processing is to be applied, however, the conventional processing software, which must perform complex calculations on each pixel, inevitably increases the amount of time required. That is why it has found only a limited use in everyday life. If the image deformation processing can be done quickly, an image shot by a hemispherical reflection mirror such as a convex mirror or a fish-eye lens, which can cover a wider viewing area than ordinary lenses, can be converted into a plane image for display. It is thus considered possible to build a surveillance system that can monitor a wide observation area with a smaller number of imaging operations.

Based on this technology, it is also considered possible to build another technology for easily monitoring sites from a remote place. In a field of broadcast, too, based on the above technology it is further considered possible with a limited number of components to track and display only a particular person or enlarge or reduce an output view of a particular area being monitored.

Under these circumstances the present invention has been accomplished after vigorous study and research and provides a remote video recognition system which allows the user at a remote place to select a desired range of a video produced by an imaging means to enlarge or reduce or track a particular person, for example.

### SUMMARY OF THE INVENTION

To achieve the above objective, the present invention provides a remote video recognition system which comprises: an imaging means installed at an arbitrary position; a transmission means for transmitting a video shot by the imaging means; and an output means installed at a position remote from where the imaging means is installed, the output means being adapted to receive video information transmitted from the transmission means and display an image according to the video information; wherein the output means is provided with an input device and an arbitrary range of the displayed image can be selected through the input means and enlarged or reduced for display; and after the arbitrary range of the image information obtained is selected through the input means, a portion of the image that is within the selected range is automatically tracked down and displayed.

In another aspect of the invention, the imaging means has an imaging device capable of capturing a curved image with a wide viewing angle. The transmission means, as claimed in claim 4, can transmit the image information taken in by the imaging means to the output means through a wired or wireless network or the Internet.

In a further aspect of this invention, at least one of the imaging means, the transmission means and the output means has a transformation means for transforming the image information into a plane image, the output means has a monitor to which the plane image transformed by the transformation means is output, and the transformation means calculates sampling points on the curved image according to a projection characteristic of the imaging device and transforms the curved image into the plane image.

In a further aspect of this invention, the transformation means may build a spherical polygon model according to the projection characteristic of the imaging device, match the sampling points on the curved image to vertices of a plurality of triangles making up the polygon model, transform the sampling points into a camera viewing system by a geometry transformation, and perform various projection conversions to transform the curved image produced by the imaging device into the plane image.

In a further aspect of this invention, rather than being provided in at least one of the imaging means, the transmission means and the output means, the transformation means may be provided in a server on the wired or wireless network or the Internet, the image information taken in by the imaging means may be transmitted by the transmission means to the server, stored there and transformed into a plane image, and the output means may connect to the wired or wireless network including the Internet to receive the image and output it to a monitor or the like.

In a further aspect of this invention, the projection characteristic of the imaging device may include parameters associated with a radius of curvature of the imaging device; the projection lens may use a fish-eye lens; and the fish-eye lens may be replaced with a hemispherical reflection mirror such as a convex or concave mirror.

In a further aspect of this invention, the output means may use a computer, a cell phone (including a PHS), or even a television receiver.

### BRIEF DESCRIPTION OF THE DRAWINGS

FIG. 1 is a schematic block diagram showing a first embodiment of the present invention.

FIG. 2 is a block diagram showing a detail of a CCD device.

FIG. 3 is a schematic diagram showing a first half of an action performed by a transformation means.

FIG. 4 is a schematic diagram showing a second half of the action performed by the transformation means.

FIG. 5A illustrates a curved image produced by a fish-eye lens and FIG. 5B illustrates a plane image converted from the curved image by a conversion program.

FIG. 6 is a schematic block diagram showing a variation of the first embodiment of the present invention.

FIG. 7 is a schematic block diagram showing a second embodiment of the present invention.

### BEST MODE FOR CARRYING OUT THE INVENTION

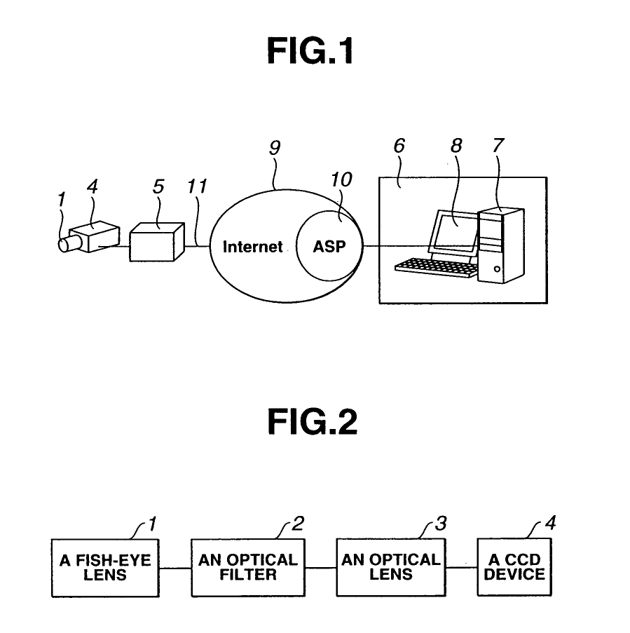

FIG. 1 shows an example embodiment of the present invention as applied to a surveillance system. The surveillance system of this embodiment includes a CCD device 4 installed at a site being monitored, a transmission means 5 for transmitting a video shot by the CCD device 4, a computer 7 installed in a monitoring center 6 remote from the site where the CCD device 4 is installed, and intended to receive video information transmitted from the transmission means 5 (in this invention the “computer” includes devices with computer functions; this applies in the following descriptions), and a monitor 8 making up the computer and displaying the video information received. The CCD device 4 corresponds to the imaging means defined in claims. In this specification, the word “computer” is intended to include general computers and other devices that incorporate CPU and MPU or the like and perform computer functions.

The CCD device 4, as shown in FIG. 2, has a fish-eye lens 1 or an imaging device, an optical filter 2, an optical lens 3, and a CCD camera 4. An image produced by the fish-eye lens 1 (curved image) is taken into the CCD device 4 through the optical filter 2 and the optical lens 3. The CCD device 4 is connected to a first controller (CPU) not shown, and thus the curved image taken into the CCD device 4 is sent to the first controller. The curved image refers to an image produced by the fish-eye lens 1. It is noted, however, that where a convex mirror, concave mirror or wide-angle lens is used in place of the fish-eye lens 1 as described later, the curved image refers to an image produced by the convex mirror, concave mirror or wide-angle lens.

The transmission means 5 is allowed by a second controller (CPU) not shown to connect to the Internet 9 via a telephone line 11, so that image information taken in from the CCD device 4 is transmitted to a server (including ASP) 10 on the Internet 9. The server 10 refers to a service in general that provides software functions via the Internet. The computer in the monitoring center 6 can connect to the server 10 through a communication device including a terminal adapter (TA). The computer 7 receives the image information from the server 10 and displays it on the monitor 8 that makes up the computer 7.

In this embodiment, a conversion means (not shown) to transform the image information is incorporated in a computer not shown which is installed in the server 10. For a connection with the Internet 9, a LAN and a wireless communication may be used in addition to the public switched telephone network.

The conversion means is a conversion program to transform the curved image taken into the CCD device 4 into a plane image. The plane image refers to an image that is presented to user's eye.

The conversion program is intended to transform the curved image produced by the fish-eye lens 1 into a plane image by calculating sampling points on the curved image based on projection characteristics of the fish-eye lens 1. That is, the process of converting a curved image formed by the imaging device into a plane image involves building a spherical polygon model based on projection characteristics including those associated with a radius of curvature of the fish-eye lens 1, matching the sampling points on the curved image to the vertices of a plurality of triangles making up the polygon model, converting them into a camera viewing field system by a geometry conversion and then performing a variety of projection conversions.

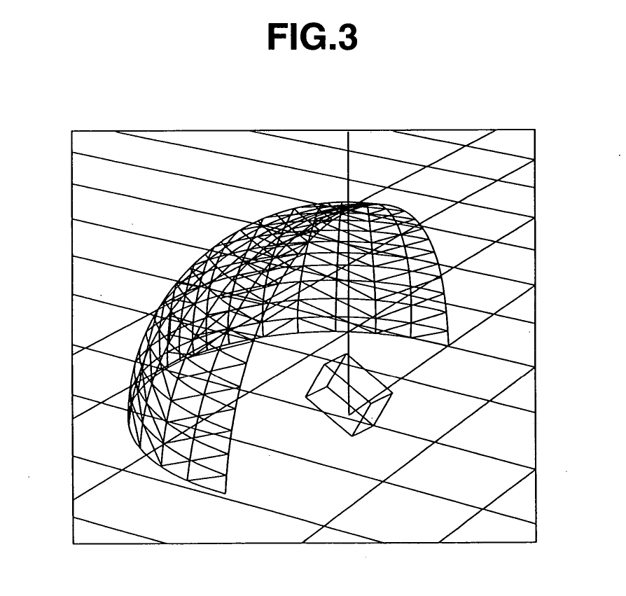

The projection characteristic of the fish-eye lens 1 has a hemispherical or pyramidal shape, as shown in FIG. 3. A sampling model marked with sampling points is imaged by the fish-eye lens 1. The sampling model imaged by the fish-eye lens 1 is shot as by the CCD device to determine destination points on the plane image (two-dimensional image) that are projected from the sampling points. Based on the destination points, a polygon model with the same or approximately the same shape as the sampling model is built on the computer. Then, the sampling points on the sampling model imaged by the fish-eye lens 1 are matched to corresponding vertices on the polygon model. In this way the projection characteristic of the fish-eye lens 1 is obtained. This projection characteristic need only be determined once. If the projection characteristic of the fish-eye lens 1 is already known, the vertices on the polygon model that match the corresponding sampling points are calculated without using the sampling model.

Based on the projection characteristic of the fish-eye lens 1 thus obtained, the vertices of a plurality of triangles on the polygon model are geometry-transformed into a camera coordinate system where they are subjected to various projection processing such as parallel projection and perspective projection to determine destination pixels on the plane that are projected from the vertices. Next, triangular sampling areas on the curved image that correspond to the triangular areas on the plane determined as described above are deformed as required. That is, for each pixel in the triangular areas on the plane, a pixel on the curved image that should be referenced is determined. These processing are not precise calculations but approximations, which can improve the processing speed.

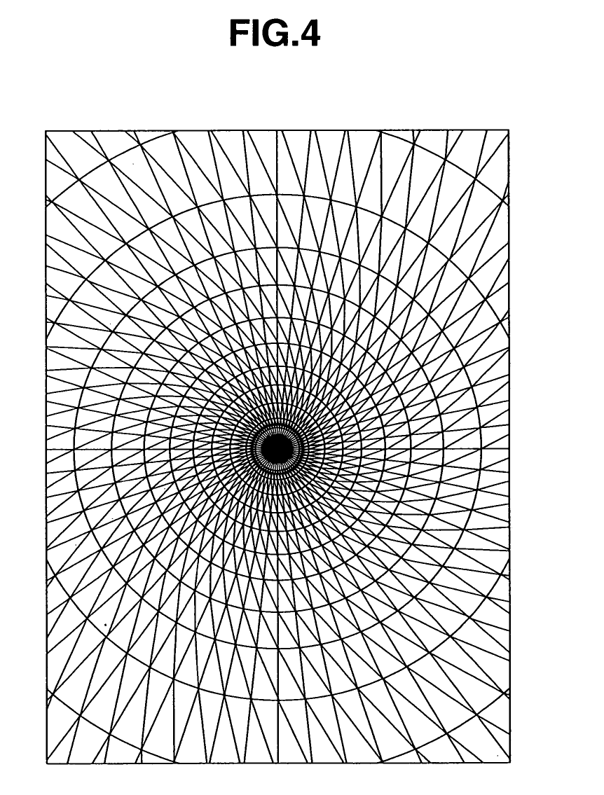

In other words, as shown in FIG. 3, the sampling points on the sampling model imaged by the fish-eye lens 1 are matched to the corresponding vertices of a plurality of triangles making up the polygon model and then geometry-transformed into a camera viewing field system where they are subjected to the above-described projection processing. That is, if a virtual camera with a line of sight, a viewing angle, a clipping plane and a banking angle is assumed to be placed in a three-dimensional space and one looks through the camera positioned at an origin of the polygon model, then he or she can see a plane image that was converted from the curved image. In practice, this conversion procedure consists in determining destination points on the two-dimensional image that are projected from the sampling points through the virtual camera and, as shown in FIG. 4, filling the triangular area of each sampling point without a gap by the affine transformation. This process obviates the need for performing complex calculations for each of a large number of pixels as required by the conventional method, and enables a fast conversion.

The plane image produced by the method of this embodiment is an approximated image. It can be made close to an actual image as by increasing the number of polygons in the polygon model to make it more resemble the sampling model or improving the density of the polygon model, as required.

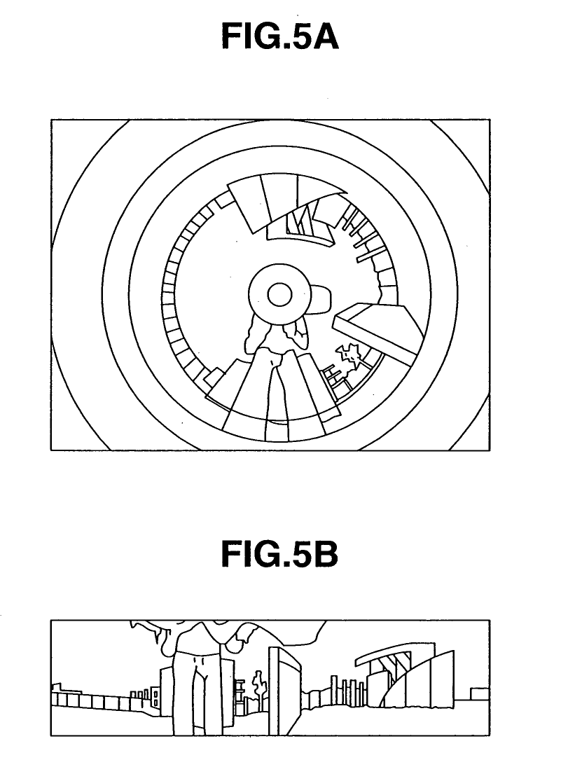

This embodiment constructed as described above operates, as follows. The fish-eye lens 1 produces an image (curved image) as shown in FIG. 5A. This curved image is taken in by the CCD device 4 which transfers the image to the computer 7 in the server 10 through the Internet 9. The curved image is then transformed into a plane image by the conversion program in the computer. The burden on the computer can be alleviated by performing the curved image-to-plane image transformation through a predetermined angle (for example, 90 degrees) at a time. As described earlier, this transformation is processed at higher speed than in the conventional method. The computer 7 serving as the output means connects to the server 10 via the Internet 9 to receive the transformed plane image. The plane image transferred to the computer 7 is then displayed on the monitor 8 of the computer 7. FIG. 5B shows a plane image displayed on the monitor 8.

In this embodiment, the user can select any desired range of the plane image output to the monitor 8 by using an input means of the computer 7, such as a mouse, and enlarge or reduce the selected range for display. This configuration can be realized by adopting a conventionally known method. Further, a desired range of the plane image, which was selected by the input means such as a mouse and displayed on the monitor 8, can be tracked. This tracking can be performed, for example, by transmitting the data of the selected range to the computer 7 on the server 10 and by having the computer select a portion of the curved image corresponding to the selected range of image data and transmit it to the computer 7. For this purpose, the computer 7 on the server 10 is provided with a storage means (e.g., a hard disk or semiconductor memory) to store the image data supplied and with a decision program that determines and selects that portion of the curved image transmitted successively from the transmission means 5 which matches the selected range of the image data. This decision program may be chosen from those available on the market in the form of software stored in a RAM (Random Access Memory).

As can be seen from FIG. 5, in this embodiment, a video of almost the entire area around the CCD device 4 which was captured by a single fish-eye lens or by the fish-eye lens 1 and the single CCD device 4 can be displayed on the monitor 8. Hence, there is no need to install a large number of surveillance cameras as required in the conventional surveillance system. Further, in this embodiment, since the video is taken in via the Internet 9, if the monitoring center 6 is located in a place or country remote from where the CCD device 4 is installed, the surveillance can be performed with ease.

The image taken in by the CCD device 4 can be subjected to additional processing by the computer in the server 10, for example, to make the face of a suspicious man more identifiable. This widens the range of applications.

Further, the ability to enlarge or reduce a selected range of the video and to track a selected range (e.g., a particular person) as described above can improve the surveillance function. This invention may also be applied to the broadcast of baseball and soccer games, whereby a viewer can choose a particular player (e.g., a forward) and enjoy a video showing that player always at the center. Alternatively, a so-called one-source-multiscreen system may be built whereby, although the same original video is received, a receiver on the viewer side can pick up a desired image portion so that each viewer can enjoy his or her own image or multiple, different images at the same time. This can realize a personal image system with ease and at low cost without requiring a huge facility investment.

Although in the above embodiment, a fish-eye lens is used for the imaging device, a hemispherical reflection mirror such as a concave or convex mirror can be employed.

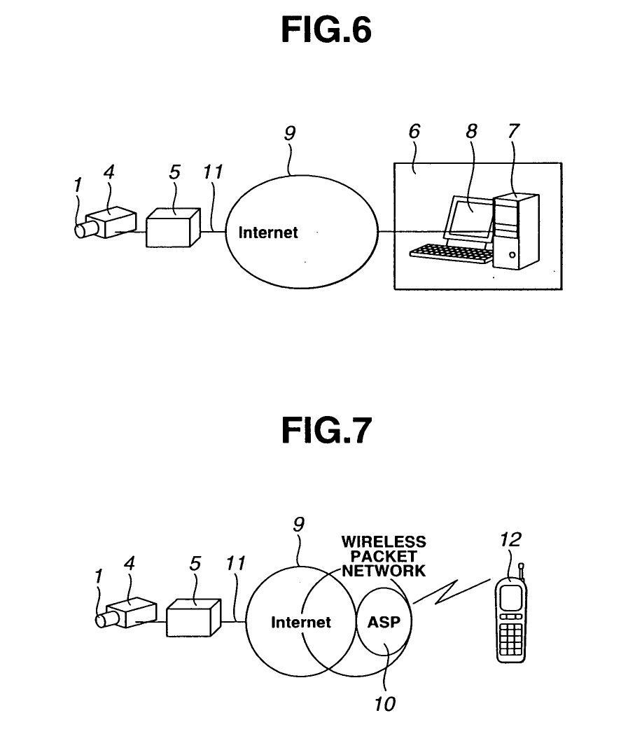

Further, in the first embodiment described above, the transformation means has been described to be installed in the computer on the server 10. In this invention, the transformation means (conversion program) may be provided in the first controller making up the CCD device 4, or the second controller making up the transmission means 5, or the computer 7 making up the output means. In other words, rather than being provided in the computer on the server 10 as described above, the conversion program may be installed in the first controller forming the CCD device 4 or in the second controller forming the transmission means 5. It may of course be installed in the computer 7 forming the output means. When this configuration is adopted, there is no need to provide the server 10 as shown in FIG. 6. The configuration shown in FIG. 6 represents a case where the conversion program is installed in the computer 7 forming the output means. In this configuration, the image data (curved image) transmitted via the transmission means 5 to the computer 7 is transformed by the computer 7 into a plane image which is then output to the monitor 8. As mentioned earlier, in this invention the conversion program may be installed in any of the devices 4, 5, 7 making up this system.

FIG. 7 shows a second embodiment of the present invention. In this embodiment the monitoring center 6 of the first embodiment is not provided and the video captured by the CCD device 4 is displayed on a cell phone or mobile terminal 12. Hence, the cell phone or mobile terminal 12 must be able to connect to the Internet. Other configurations and operations are similar to those of the first embodiment.

With this embodiment, a variety of applications are conceivable. For example, the CCD device 4 may be installed in a kindergarten or home so that a mother working in an office can watch her child in the kindergarten or home by using her cell phone 12. In this case, by using a memory in the computer at home or a server on an internet service provider side, it is possible not only to realize the real-time observation but also to view a recorded and stored video by fast-feeding it. Further, at kindergartens and homes, it is possible to build an observation system by simply installing the CCD device 4 and necessary software. Therefore, this embodiment has an excellent versatility.

In this invention, the cell phone 12 may be replaced with a portable computer or PDA. It is also possible to use a PHS or even a TV receiver in the place of the cell phone.

In the above embodiment, we have described an example case where a desired portion of the image is selected from the plane image output to the monitor 8. This invention is not limited to this arrangement, and the desired portion of the image may be selected from the curved image captured by the imaging means such as the CCD device 4 or from the image transmitted by the transmission means. Further, the selected portion of the image does not need to be transformed into a plane image and may be recorded and stored as is. The selected portion of the image may also be tracked and then recorded and stored without converting it into the plane image.

### Industrial Applicability

Since the present invention is configured and operates as described above, a portion of the image that is selected using an input means can be enlarged or reduced, or tracked down. This not only improves the surveillance function but also allows the application of the invention to the television broadcast whereby a viewer can select a particular person and watch the TV showing that person at the center of the screen. This invention can also realize a one-source-multiscreen system, thus offering new ways to enjoy the TV broadcasting. Further, the use of a curved image shooting means can realize fast image transformation processing. This invention therefore can be applied at low cost to a variety of equipment including a surveillance system.

1 (canceled):

2 (canceled):

3 (canceled):

4 (canceled):

5 (canceled):

6 (canceled):

7 (canceled):

8 (canceled):

9 (canceled):

10 (canceled):

11 (canceled):

12 (canceled):

13 (canceled):

14 (canceled):

15 A remote video recognition system comprising:
an imaging means with a wide viewing angle installed at an arbitrary position;
a transmission means for transmitting a video shot by the imaging means;
an output means installed at a position remote from where the imaging means is installed, the output means being adapted to receive video information transmitted from the transmission means and display an image according to the video information;
wherein the output means is provided with an input device and an arbitrary range or area of the displayed image can be selected through the input means and enlarged or reduced for display; and
after the arbitrary range or area of the image information obtained is selected through the input means, a portion of the image that is within the selected range is manually or automatically tracked down by a means such as a mouse or cursor and displayed.

16 A remote video recognition system according to claim 15, wherein the imaging means has an imaging device capable of capturing a curved image with a wide viewing angle.

17 A remote video recognition system according to claim 15 or claim 16, wherein the transmission means can transmit the image information taken in by the imaging means to the output means through a wired or wireless network.

18 A remote video recognition system according to claim 15 to or claim 16, wherein at least one of the imaging means, the transmission means and the output means has a transformation means for transforming the image information into a plane image, and the transformation means calculates sampling points on the curved image according to a projection characteristic of the imaging device and transforms the curved image into the plane image.

19 A remote video recognition system according to claim 18, wherein the transformation means builds a spherical polygon model according to the projection characteristic of the imaging device, matches the sampling points on the curved image to vertices of a plurality of triangles making up the polygon model, transforms the sampling points into a camera viewing system by a geometry transformation, and performs various projection conversions and rasterization to transform the curved image produced by the imaging device into the plane image.

20 A remote video recognition system according to claim 19, wherein, rather than being provided in at least one of the imaging means, the transmission means and the output means, the transformation means is provided in a server on the wired or wireless network, the image information taken in by the imaging means can be stored in the server and transformed into a plane image, and the output means connects to the wired or wireless network including the Internet to receive the image and output it to a monitor or the like.

21 A remote video recognition system according to claim 15 or claim 16, wherein the projection characteristic of the imaging device includes parameters associated with a radius of curvature of the imaging device.

22 A remote video recognition system according to claim 15 or claim 16, wherein the imaging device is a hemispherical reflection mirror or a projection lens.

23 A remote video recognition system according to claim 22, wherein the projection lens is a fish-eye lens.

24 A remote video recognition system according to claim 22, wherein the hemispherical mirror is a convex mirror or a concave mirror.

25 A remote video recognition system according to claim 15 or claim 16, wherein the output means is a computer.

26 A remote video recognition system according to claim 15 or claim 16, wherein the output means is a cell phone.

27 A remote video recognition system according to claim 15 or claim 16, wherein the output means is a television receiver.
